(19) United States
(12) Patent Application Publication
(10) Pub. No.: US 2006/0190260 A1
(43) Pub. Date: Aug. 24, 2006

(54) Selecting an order of elements for a speech synthesis

(75) Inventor: Juha Iso-Sipila, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/067,317

(22) Filed: Feb. 24, 2005

(51) Int. Cl. G10L 13/00

(52) U.S. Cl. 704/258

(57) ABSTRACT

In a method for selecting an order of elements which are to be subject to a speech synthesis, a voice input including at least two elements is received, wherein the at least two elements have an arbitrary order. Thereupon, a search is caused in a database for an entry which includes a combination of these at least two elements. If such an entry is recognized in the database, a speech synthesis of the at least two elements from the database entry, using the order of said at least two elements in said voice input, is caused. As the order of the synthesized elements thus corresponds to the order of elements in the voice input, the user experience is improved.

### FIELD OF THE INVENTION

The invention relates to a method for selecting an order of elements which are to be subject to a speech synthesis. The invention relates equally to a corresponding device, to a corresponding communication system and to a corresponding software program product.

### BACKGROUND OF THE INVENTION

Speech synthesis can be made use of for various applications, for example in the scope of voice based applications which are controlled by voice commands. It can be used in particular for enabling speaker-independent voice prompts. A speaker-dependent voice prompt technology requires a user to pronounce a word in a separate training session before a voice prompt can be used. In the case of speaker-independent voice prompts, no such training is required. The voice prompt is generated instead from textual data by means of a speech synthesis.

For some voice based applications, a user may provide a voice input comprising a sequence of words to a system. The system then looks up the sequence of words in a database using an automatic speech recognition (ASR) technique.

More specifically, an ASR engine performs a matching between a speech input of a user and pre-generated voicetag templates. The ASR engine may have several templates for each item in the database, for instance for multiple languages. In the matching process the speech is segmented into small frames, typically having a length of 30 ms each, and further processed to obtain so called feature vectors. Typically, there are 100 feature vectors per second. It matches the input feature vectors to all templates, chooses the one that has the maximum probability and provides this template as the result. The result provided by the ASR engine can then be matched with the database entries.

When an assumed correspondence is found, the system synthesizes the sequence of words found in the database by means of a text-to-speech (TTS) synthesis and outputs the synthesized speech in order to inform the user about the recognized sequence. This allows the user to verify whether the voice input was understood correctly by the system. The recognized words can then form the basis for some further operation, depending on the respective application.

Such an application may be, for example, a voice dialing application. In a voice dialing application, a user usually inputs to a telephone the name of a person to which a connection is to be established as a voice command. If the telephone recognizes the name and an associated phone number in a database, the name is repeated for the user to confirm the selection. Upon such a confirmation, the number is dialed automatically by the telephone, in order to establish the connection.

In most languages, the natural order of names is ‘given name’ followed by ‘family name’. In some languages, like Chinese and Hungarian, this basic rule is not valid though. For native speakers of these languages, it is unnatural to say ‘Imre Kiss’ when Imre is the given name and Kiss the family name. When using a voice dialing application, a native speaker of such a language would prefer saying ‘Kiss Imre’ and also expect to obtain a confirmation by the speech synthesizer saying ‘Kiss Imre’. Furthermore, if Hungarians, for example, have an English name ‘John Smith’ in the phonebook, they might prefer saying and hearing ‘John Smith’ in spite of their regular native language order.

In conventional multilingual speech recognition systems, only a single order of names is supported. Thereby, the system knows which order to expect. All users must use, for example, the order ‘given name, family name’ in a voice input. This will cause inconvenience to the users of some languages.

Similar problems might arise in other voice based applications. The problems do not have to be caused necessarily by the difference between languages either. A user might have for other reasons a preference to use a particular order of words required in a voice command, or the user might not know in which order the words are expected by the application. In most applications, the command words have to be given in a predetermined order, which is also the order in which they are synthesized for a TTS output.

### SUMMARY OF THE INVENTION

It is an object of the invention to improve the user experience when a recognized voice input is confirmed by synthesized speech.

A method for selecting an order of elements which are to be subject to a speech synthesis is proposed. The method comprises receiving a voice input including at least two elements, wherein the at least two elements have an arbitrary order. The method further comprises causing a search in a database for an entry which includes a combination of the at least two elements. If such an entry is recognized in the database, the method further comprises causing a speech synthesis of the at least two elements from the database entry, using the order of the at least two elements in the voice input.

Moreover, a device is proposed, which comprises a processing unit. The processing unit is adapted to receive a voice input including at least two elements, which have an arbitrary order. The processing unit is further adapted to cause a search for an entry in a database, which entry includes a combination of at least two elements of a received voice input. The processing unit is further adapted to cause a speech synthesis of at least two elements from a recognized database entry, using the order of at least two elements in a received voice input.

Moreover, a communication system is proposed, which comprises a corresponding processing unit.

Finally, a software program product is proposed, in which a software code for selecting an order of elements which are to be subject to a speech synthesis is stored. When running in a processing unit, the software code realizes the proposed method.

The invention proceeds from the consideration that each element belonging to a combination of elements can be stored as separately accessible information in a database. Such a separate access is enabled, for example, by the Symbian operating system. According to the invention, the order of elements in a voice input can be arbitrary, and the order of elements in a synthesized confirmation of a voice input is based on the order elements in the voice input itself. The elements can be in particular, though not exclusively, words.

It is an advantage of the invention that in spite of the arbitrary order of elements in a voice input, the synthesized response is similar to the voice input and has no contradiction in the order of elements. As a result, inconveniences to a user are reduced, since the user can determine the preferred order of the elements for input and output.

It is further an advantage of the invention that it is easy to implement and that it requires little additional memory and/or processing.

A recognition unit can operate very accurately, even in case of an arbitrary order of input elements. Only in case of very similar sounding given and family names, a result may be incorrect.

The proposed method can be realized by way of example by an application programmer's interface (API) or by an application. Either may be run by a processing unit.

Causing the speech synthesis as proposed may be realized in various ways.

In one embodiment of the invention, causing the speech synthesis comprises providing the at least two elements from the database entry to a speech synthesizer in the order of the at least two elements in the voice input. When the speech synthesizer synthesizes the elements, they are thus automatically in the desired order.

In another embodiment of the invention, causing the speech synthesis comprises providing the at least two elements from the database entry to a speech synthesizer in the order in which they are stored in the database. In addition, an indication of the order of the at least two elements in the voice input is provided to the speech synthesizer. The elements can then be arranged by the speech synthesizer in accordance with the provided indication so that the elements are synthesized in the desired order.

The proposed device and the proposed system may comprise in addition a speech recognition unit adapted to match the at least two elements of a voice input with available voicetag templates. The processing unit is adapted in addition to search for an entry in a database which includes a combination of the at least two elements based on matching results provided by the speech recognition unit.

The proposed device and the proposed system may comprise in addition a speech synthesizing unit, which is adapted to synthesize at least two elements provided by the processing unit, using the order of at least two elements in a received voice input.

The proposed device and the proposed system may moreover include the database in which the entries are stored.

The invention can be implemented in any device which enables a direct or indirect voice input.

The invention could be implemented, for instance, in a user device. Such a user device can be for example a mobile terminal or a fixed phone, but the user device is not required to be a communication device. The invention can equally be implemented, for instance, in a network element of a communication network. It can equally be implemented, for instance, in a server of a call center, which can be reached by means of a user device via a communication connection.

If the invention is implemented in a communication system, the processing unit may be for instance a part of a user terminal, a part of a network element of a communication network or a part of a server which is connected to a communication network.

It is to be understood that if the invention is implemented in a communication system, the processing unit, the speech recognition unit, the speech synthesizing unit and the database may also be distributed to two or more entities.

The invention can be employed for any voice based application, which provides a speech synthesized confirmation of a recognized voice input. Voice dialing is only one example of such an application. The at least two elements can form in particular a voice command for such a voice based application. In particular if used for a voice dialing application, the at least two elements may comprise for example a given name and a family name.

Another exemplary use case is a calendar application, in which the user may input a day and month, in order to be informed about the entries for this date. With the invention, the user is enabled to say either “December second” or “second December”, and he obtains as well a corresponding confirmation in both cases.

It has to be noted that the determined order of the elements of the voice input need not only be used for an immediate voice input confirmation. It could also be stored in addition for a later use of the elements in a preferred order. It could be stored, for example, as a further part of the recognized database entry.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a device according to an embodiment of the invention;

FIG. 2 is a flow chart illustrating an operation in the device of FIG. 1; and

FIG. 3 is a schematic block diagram of a system according to an embodiment of the invention.

### DETAILED DESCRIPTION OF THE INVENTION

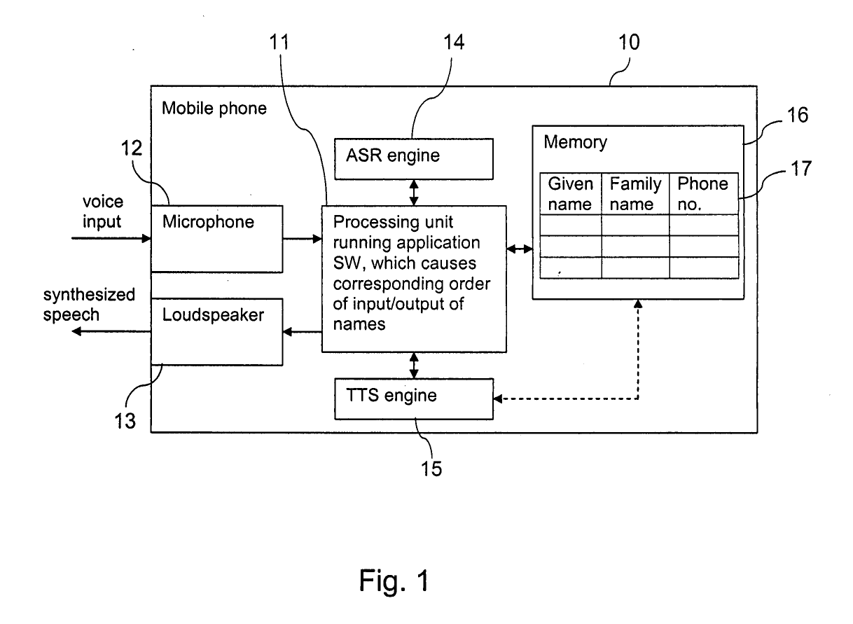

FIG. 1 is a schematic block diagram of a device, which enables a speech confirmation of a voice input in accordance with an embodiment of the invention.

By way of example, the device is an enhanced conventional mobile phone 10. In FIG. 1, only components of the mobile phone 10 which are related to the invention are depicted. The mobile phone 10 comprises a processing unit 11 which is able to run software (SW) for a voice based dialing application. The mobile phone 10 further comprises a microphone 12 and a loudspeaker 13 as parts of a user interface. The mobile phone 10 further comprises an automatic speech recognition (ASR) engine 14 as an ASR unit, a text-to-speech (TTS) engine 15 as a TTS unit, and a memory 16. The term “engine” refers in this context to the software module that implements the required functionality in question, that is, either ASR or TTS. Each engine is more specifically a combination of several algorithms that have been implemented as software and can perform the requested operation. A common terminology for ASR is a Hidden Markov Model based speech recognition technology. TTS is commonly divided in two classes, parametric speech synthesis and waveform concatenation speech synthesis.

The processing unit 11 has access to the microphone 12, to the loudspeaker 13, to the ASR engine 14, to the TTS engine 15 and to the memory 16. In addition, the TTS engine 15 could have a direct access to the memory 16 as well, which is indicated by dashed lines. The memory 16 stores data 17 of a phonebook, which associates a respective phone number to a respective combination of a given name and a family name. Given name and family name are stored as separate information. It is to be understood that the presented contents and formats of the phonebook have only an illustrative character. The actual contents and formats may vary in many ways, and the phonebook may contain a lot of other information as well.

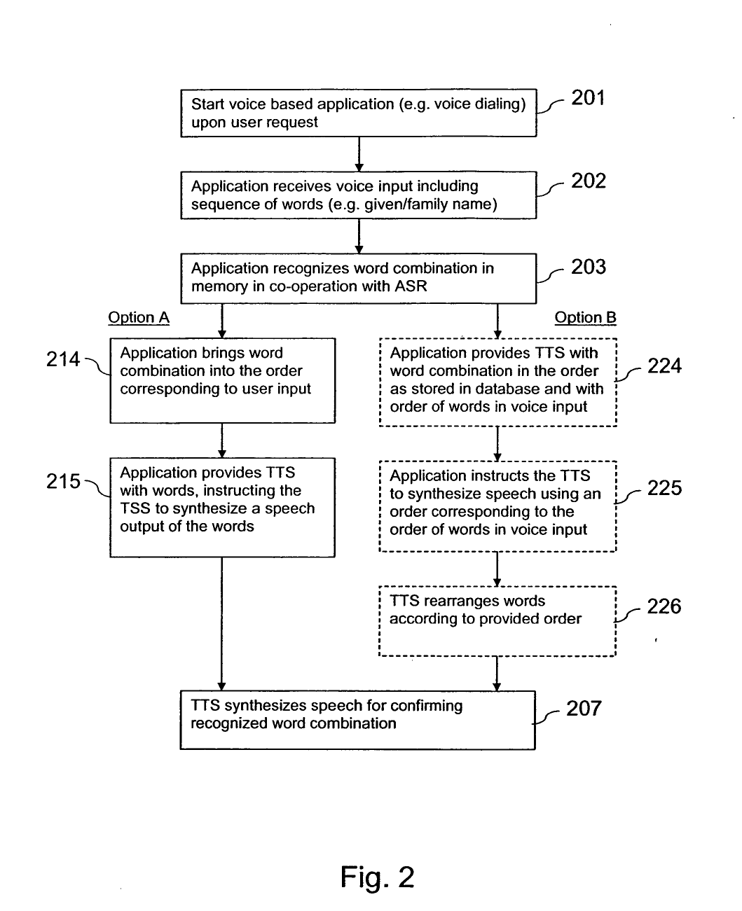

The functioning of the mobile phone 10 in the case of voice dialing will now be described with reference to the flow chart of FIG. 2.

A user of the mobile phone 10 may wish to establish a connection to another person by means of voice dialing. The user may initiate the voice dialing for example by selecting a corresponding menu item displayed on a screen of the mobile phone 10 or by pressing a dedicated button of the mobile phone 10 (not shown). Thereupon, the voice dialing application is started by the processing unit 11 (step 201).

The application now waits for a voice input via the microphone 12, which should include a given name and a family name in an arbitrary order. When a voice input is received, it is forwarded by the application to the ASR engine 14 (step 202).

The ASR engine 14 matches the words in the voice input with available voicetag templates. Based on the results, the processing unit 11 searches for matching character based entries of the phonebook, considering both the possible order ‘given name, family name’ and the possible order ‘family name, given name’. If a correspondence is found in one entry, the given name, the family name and an associated phone number belonging to this entry are extracted from the memory 16. The processing unit 11 may provide the search results with result indices identifying the order in which the names were found. For example, the extracted ‘given name’ may be provided with a result index ‘1’ and the extracted ‘family name’ with a result index ‘2’, in case a first part of the voice input was found to correspond to a given name of an entry and the second part of the voice input was found to correspond to the associated family name of this entry. Further, the extracted ‘given name’ may be provided with a result index ‘2’ and the extracted ‘family name’ with a result index ‘1’, in case a first part of the voice input was found to correspond to a family name entry and the second part of the voice input was found to correspond to an associated given name entry (step 203). In case no correspondence is found, the user is requested to enter the name again in a known manner.

Before the application establishes a connection based on the received telephone number, the application indicates to the user which name combination in the phonebook has been recognized.

In a first alternative, indicated in FIG. 2 as option A, the application arranges the name combination to this end into the order corresponding to the voice input by the user. For example, if the processing unit 11 provides the extracted ‘given name’ with a result index ‘1’ and the extracted ‘family name’ with a result index ‘2’, the application maintains the order of the extracted name combination. But if the processing unit 11 provides the extracted ‘given name’ with a result index ‘2’ and the extracted ‘family name’ with a result index ‘1’, the application reverses the order of the received name combination (step 214).

The application then provides the TTS engine 15 with the possibly rearranged name combination and orders the TTS engine 15 to synthesize a corresponding speech output (step 215).

The TTS engine 15 finally synthesizes the speech, which is output via the loudspeaker 13, in order to confirm the name combination recognized in the phonebook to the user (step 207).

In a second alternative, indicated in FIG. 2 as option B and with dashed lines, the application provides the TTS engine 15 with the name combination in the order as extracted from the memory 16 (step 224).

In addition, the application instructs the TTS engine 15 to synthesize a corresponding speech output using a particular order of names (step 225). For example, if the processing unit 11 provides the extracted ‘given name’ with a result index ‘1’ and the extracted ‘family name’ with a result index ‘2’, the application instructs the TTS engine 15 to maintain the order of the extracted and forwarded name combination. But if the processing unit 11 provides the extracted ‘given name’ with a result index ‘2’ and the extracted ‘family name’ with a result index ‘1’, the application instructs the TTS engine 15 to reverse the order of the extracted and forwarded name combination.

The TTS engine 15 rearranges the received name combination as far as required according to the instructions by the application (step 226).

The TTS engine 15 finally synthesizes speech based on the rearranged word combination, and the speech is output via the loudspeaker 13, in order to confirm the name combination recognized in the phonebook to the user (step 207).

It is to be noted that the TTS engine 15 could also retrieve the contact information directly from the memory 16 without the help of the ASR engine 14, as indicated in FIG. 1 by the dashed lines between the TTS engine 15 and the memory 16. The ASR engine 14 is aware of the pronunciations rather than of the written format. A different pronunciation modeling scheme could therefore be implemented in the TTS engine 15, which more accurately reflects the phonetic content of a particular language.

In case the name combination recognized in the phonebook corresponds to the conversation partner intended by the user, the user may confirm in a conventional manner that the voice input has been recognized correctly and that the dialing can be performed. Thereupon, the application establishes a connection using the associated telephone number. If the user simply stays silent, this may also be interpreted as a confirmation. That is, after a short timeout the connection is established. In case the user rejects the recognized name combination, the application may invite the user to repeat the voice input and the described procedure is repeated. In addition to a simple confirmation and rejection, the user may also be enabled to choose to check the next best matches, etc.

Since the speech for the confirmation is always synthesized based on the same order of words as used by the user for the voice input, the user will not be irritated by a reversed order of words in the confirmation.

It has to be noted that instead of a mobile phone 10, the apparatus could equally be another type of device. Moreover, the processing unit 11 could run any other speech based application than a voice dialing application, for which an indication of a recognized database entry is preferably provided in the same order as the words in a preceding voice input.

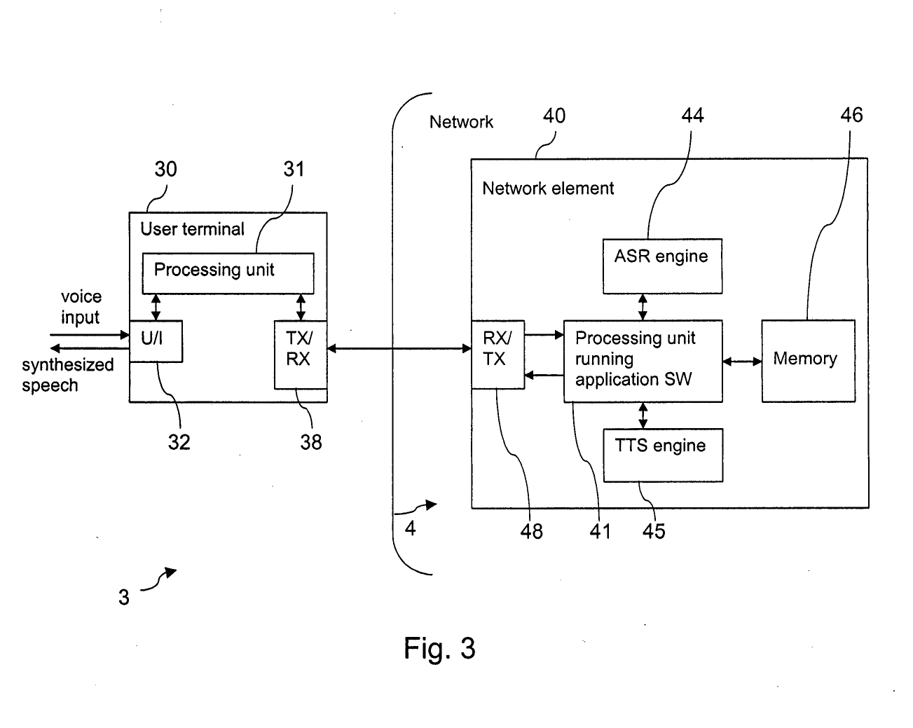

FIG. 3 is a schematic block diagram of a communication system, which enables a speech confirmation of a voice input in accordance with an embodiment of the invention.

In FIG. 3, only components of the system 3 which are related to the invention are depicted. The system 3 comprises a user terminal 30 and a communication network 4. The user terminal 30 can be, for example, a mobile phone, a stationary phone or a personal computer, etc.

The communication network 4 includes a network element 40 comprising a processing unit 41, an ASR engine 44, a TTS engine 45, a communication unit RX/TX 48 and a memory 46. The processing unit 41 is adapted to run a voice based application. The processing unit 41 is connected to the ASR engine 44, the TTS engine 45 and the communication unit 48. Moreover, it has access to the memory 46. The memory 46 stores entries of a database, which associates a respective parameter to a respective combination of at least two words.

The user terminal 30 comprises a user interface U/I 32, including a microphone, a loudspeaker, a screen and keys (not shown), and a communication unit RX/TX 38. The user terminal 30 further comprises a processing portion 31 that is connected to the user interface 32 and to the communication unit 38.

Any communication between the user terminal 30 and the network element 40 takes place via the communication unit 38 of the user terminal 30 on the one hand and the communication unit 48 of the network element 40 on the other hand.

The functioning of the communication system of FIG. 3 for a voice based application is quite similar to the functioning of the mobile phone 10 of FIG. 1, except that the functions are performed in a network element 40 and that a voice input to the user terminal 30 by a user is provided to the network element 40 via the communication network 4.

The functioning of the communication system 3 of FIG. 3 will now be described in more detail, again with reference to FIG. 2.

A user of the user terminal 30 may request a voice based application offered by the communication network, for example by selecting a corresponding menu item displayed on the screen. The processing portion 31 of the user terminal 30 establishes a connection with the communication network 4 and forwards the request to the communication network 4. The network element 40 receives the request. The voice based application is started thereupon in the network element 40 by the processing unit 41 (step 201).

The application requests from the processing unit 31 of the user terminal 30 a voice input via the communication network 4. When the processing portion 31 receives a voice input via the user interface 32, this voice input is forwarded to the network element 40. Within the network element 40, the voice input is transferred to the processing unit 41 and further to the ASR engine 44 (step 202).

The ASR engine 14 matches the words in the voice input with available voicetag templates. Based on the results, the processing unit 11 searches for matching entries in the database stored in the memory 46. If a word combination corresponding to the words in the voice input is recognized in one of the entries, the words of the word combination and an associated parameter are extracted from the memory 46. The results may be provided with result indices identifying the order in which the words of the voice input are present in the database entry (step 203).

Before the application activates a function using the parameter which is associated to the word combination, it indicates to the user exactly which word combination has been recognized in the database. There are again several alternatives, of which two are described.

In a first alternative, the application arranges the recognized word combination into the order corresponding to the words in the voice input by the user (step 214).

The application then provides the TTS engine 45 with the possibly rearranged word combination and instructs the TTS engine 45 to synthesize a corresponding speech output (step 215).

The TTS engine 45 finally synthesizes the speech and provides it to the application (step 207).

In a second alternative, the application provides the TTS engine 45 with the recognized word combination in the order in which it was extracted from the memory 46 (step 224).

In addition, the application instructs the TTS engine 45 to synthesize a corresponding speech output using a particular order of words, namely the order of words used by the user for the voice input (step 225).

The TTS engine 45 arranges the received word combination accordingly (step 226).

Also in this second alternative, the TTS engine 45 finally synthesizes the speech and provides it to the application (step 207).

In both alternatives, the synthesized speech is then forwarded via the communication network 4 to the user terminal 30. In the user terminal 30, the processing unit 31 takes care that the synthesized speech is output via the user interface 32, in order to inform the user about the recognized word combination.

In case the recognized word combination corresponds to the word combination desired by the user, the user may confirm in a conventional manner that the voice input has been recognized correctly and that a function associated to the requested voice based application can be performed. Thereupon, the application carries out the function based on the parameters associated to the recognized word combination. In case the user does not confirm that the voice input has been recognized correctly, the user may be invited to repeat the voice input and the described procedure is repeated.

It has to be noted that the described functions of the network element could be implemented as well in another device, for example in a server of a call center which is connected to the communication network.

Further, the processing unit, the ASR engine 44, the TTS engine 45 and the database 46 could also be distributed to two or more entities. For example, the speech recognition and the database entry search could be performed in a server, while the speech synthesis is performed in a user terminal. Alternatively, the speech synthesis could be performed in a server, while the database is stored in a user terminal, which also performs the database entry search. The recognition could be performed in this case either in the user terminal or in the server. Many other combinations are possible as well.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. Method for selecting an order of elements which are to be subject to a speech synthesis, said method comprising:
receiving a voice input including at least two elements, wherein said at least two elements have an arbitrary order;
causing a search in a database for an entry which includes a combination of said at least two elements;
and
if such an entry is recognized in said database, causing a speech synthesis of said at least two elements from said database entry, using the order of said at least two elements in said voice input.

2. The method according to claim 1, wherein causing said speech synthesis comprises providing said at least two elements from an entry recognized in said database to a speech synthesizer in the order of said at least two elements in said voice input.

3. The method according to claim 1, wherein causing said speech synthesis comprises providing said at least two elements from an entry recognized in said database to a speech synthesizer in an order in which they are stored in said database, together with an indication of the order of said at least two elements in said voice input.

4. The method according to claim 1, wherein said at least two elements of said voice input form a voice command for a voice based application.

5. The method according to claim 4, wherein said voice based application is a voice dialing application.

6. The method according to claim 1, wherein said at least two elements comprise a given name and a family name.

7. The method according to claim 1, wherein said at least two elements comprise at least a day and month of a date.

8. Device comprising a processing unit,
wherein said processing unit is adapted to receive a voice input including at least two elements, which at least two elements have an arbitrary order;
wherein said processing unit is adapted to cause a search for an entry in a database, which entry includes a combination of said at least two elements; and
wherein said processing unit is adapted to cause a speech synthesis of at least two elements from a recognized database entry, using the order of said at least two elements in said voice input.

9. The device according to claim 8, wherein said processing unit is adapted to provide for said speech synthesis said at least two elements from said database entry in the order of said at least two elements in said voice input.

10. The device according to claim 8, wherein said processing unit is adapted to provide for said speech synthesis said at least two elements from said database entry in an order in which they are stored in said database, together with an indication of the order of said at least two elements in said voice input.

11. The device according to claim 8, further comprising a speech recognition unit, which speech recognition unit is adapted to match said at least two elements of said voice input with available voicetag templates, wherein said processing unit is further adapted to search for an entry in said database which includes a combination of said at least two elements based on matching results provided by the speech recognition unit.

12. The device according to claim 8, further comprising a speech synthesizing unit, which speech synthesizing unit is adapted to synthesize at least two elements provided by said processing unit using the order of said at least two elements in said voice input.

13. The device according to claim 8 further comprising said database.

14. The device according to claim 8, wherein said device is a user device.

15. The device according to claim 8, wherein said device is a network element of a communication network.

16. The device according to claim 8, wherein said device is a server which is adapted to communicate via a communication network.

17. A communication system comprising a processing unit,
wherein said processing unit is adapted to receive a voice input including at least two elements;
wherein said processing unit is adapted to cause a search for an entry in a database which includes a combination of said at least two elements; and
wherein said processing unit is adapted to cause a speech synthesis of at least two elements from a database entry, using a received order of said at least two elements in said voice input.

18. The communication system according to claim 17 comprising a user terminal, which user terminal includes said processing unit.

19. The communication system according to claim 17 comprising a network element of a communication network, which network element includes said processing unit.

20. The communication system according to claim 17 comprising a communication network and a server, wherein said server is connected to said communication network and wherein said server includes said processing unit.

21. A software program product in which a software code for selecting an order of elements which are to be subject to a speech synthesis is stored, said software code realizing the following steps when running in a processing unit:
receiving an input that is obtained from a voice input including at least two elements, wherein said at least two elements have an arbitrary order;
causing a search in a database for an entry which includes a combination of said at least two elements; and
if such an entry is recognized in said database, causing a speech synthesis of said at least two elements from said database entry, using the order of said at least two elements in said voice input.
